(19) United States
(12) Patent Application Publication
(10) Pub. No.: US 2013/0289456 A1
(43) Pub. Date: Oct. 31, 2013

(54) GARMENT BASED AIRWAY CLEARANCE SYSTEMS AND METHODS

(71) Applicants: Mike Yang Chang Guo, Singapore (SG); Boon Khai Ang, Singaport (SG); Beng Leong Toh, Singapore (SG)

(72) Inventors: Mike Yang Chang Guo, Singapore (SG); Boon Khai Ang, Singaport (SG); Beng Leong Toh, Singapore (SG)

(21) Appl. No.: 13/852,520

(22) Filed: Mar. 28, 2013

(30) Foreign Application Priority Data
Mar. 30, 2012 (MY) PI 2012001476

(51) Int. Cl. A61H 9/00

(52) U.S. Cl. CPC A61H 9/0007
USPC 601/149

(57) ABSTRACT

A garment based airway clearance system for mobilizing secretions in a patient's airway and related methods are disclosed. The garment based airway clearance system comprises a therapy chamber mounted substantially around the circumference of the garment such that inflation of the therapy chamber causing a compressive force to be applied on the thorax or chest of the wearer of the garment.

### BACKGROUND

Devices exist for aiding in removal of secretions from the airway of children and adults with certain symptoms by mobilizing secretions. While several systems and methods are available to mobilize secretions in the airway, a need persists for continued development in this area.

### BRIEF SUMMARY

The present disclosure includes one or more of the features recited in the appended claims and/or the following features which, alone or in any combination, may comprise patentable subject matter.

One embodiment of an airway clearance system for mobilizing secretions in a is patient's airway comprises a garment comprising a first air retentive chamber. A second air retentive chamber comprising a moving plate is fluidly connected with the first air retentive chamber. A fluid supply is configured to supply air to at least one of the first and second air retentive chambers and an actuator is configured to actuate the moving plate to vary the volume of the second air retentive chamber, thereby varying the pressure in the first air retentive chamber.

Another embodiment of an airway clearance system for mobilizing secretions in a patient's airway comprises a garment comprising a fluid retentive chamber comprising at least one wall configured to actuate and thereby vary volume of the fluid retentive chamber, an actuator configured to actuate the at least one wall to vary the volume and thereby the pressure inside the fluid retentive chamber. A fluid supply is configured to supply fluid to the fluid retentive chamber and a processor is configured to provide command signals to the actuator.

Another embodiment of a garment based airway clearance system for mobilizing secretions in a patient's airway comprises a garment housing a means for varying volume of a fluid retentive chamber thereby varying pressure in the fluid retentive chamber.

Another embodiment of the garment based airway clearance system for mobilizing secretions in a patient's airway comprises a fluid retentive chamber comprising at least one wall configured to pivot about a pivot axis and thereby vary volume of the fluid retentive chamber. An actuator configured to actuate the at least one wall to vary the volume and thereby the pressure inside the fluid retentive chamber.

Yet another embodiment of the garment based airway clearance system for mobilizing secretions in a patient's airway comprises a fluid retentive chamber comprising a moving plate configured to translate with respect to a stationary plate and thereby vary volume of the fluid retentive chamber and an actuator configured to actuate the moving plate to vary the volume and thereby pressure inside the fluid retentive chamber.

### BRIEF DESCRIPTION OF DRAWINGS

The accompanying drawings incorporated in and forming a part of the specification illustrate several aspects of the claimed subject matter and, together with the description, serve to explain the principles of the claimed subject matter. In the drawings:

FIG. 1 is a perspective front view of the garment based airway clearance system, constructed according to one or more of the principles disclosed herein;

FIG. 2 is a perspective front view of one embodiment of the garment based airway clearance system, constructed according to one or more of the principles disclosed herein;

FIG. 3 is a perspective front view of another embodiment of the garment based airway clearance system, constructed according to one or more of the principles disclosed herein;

FIG. 4 is an embodiment of the air pressure pulse generator and some components of the garment based airway clearance system, constructed according to one or more of the principles disclosed herein;

FIG. 5 is another embodiment of the air pressure pulse generator and some components of the garment based airway clearance system, constructed according to one or more of the principles disclosed herein;

FIG. 6 is a block diagram showing connectivity between some components of the garment based airway clearance system in one embodiment, constructed according to one or more of the principles disclosed herein;

FIG. 7 is a block diagram showing connectivity between some components of the garment based airway clearance system in another embodiment, constructed according to one or more of the principles disclosed herein;

FIG. 8 is yet another embodiment of the air pressure pulse generator and some components of the garment based airway clearance system, constructed according to one or more of the principles disclosed herein;

### DETAILED DESCRIPTION OF ILLUSTRATIVE EMBODIMENTS

The embodiments of the claimed subject mater and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be briefly mentioned or omitted so as to not unnecessarily obscure the embodiments of the claimed subject matter described. The examples used herein are intended merely to facilitate an understanding of ways in which the claimed subject matter may be practiced and to further enable those of skill in the art to practice the embodiments of the claimed subject matter described herein. Accordingly, the examples and embodiments herein are merely illustrative and should not be construed as limiting the scope of the claimed subject matter, which is defined solely by the appended claims and applicable law. Moreover, it is noted that like reference numerals represent similar parts throughout the several views of the drawings.

It is understood that the subject matter claimed is not limited to the particular methodology, protocols, devices, apparatus, materials, applications, etc., described herein, as these may vary. It is also to be understood that the terminology used herein is used for the purpose of describing particular embodiments only, and is not intended to limit the scope of the claimed subject matter.

Unless defined otherwise, all technical and scientific terms used herein have the same meanings as commonly understood by one of ordinary skill in the art.

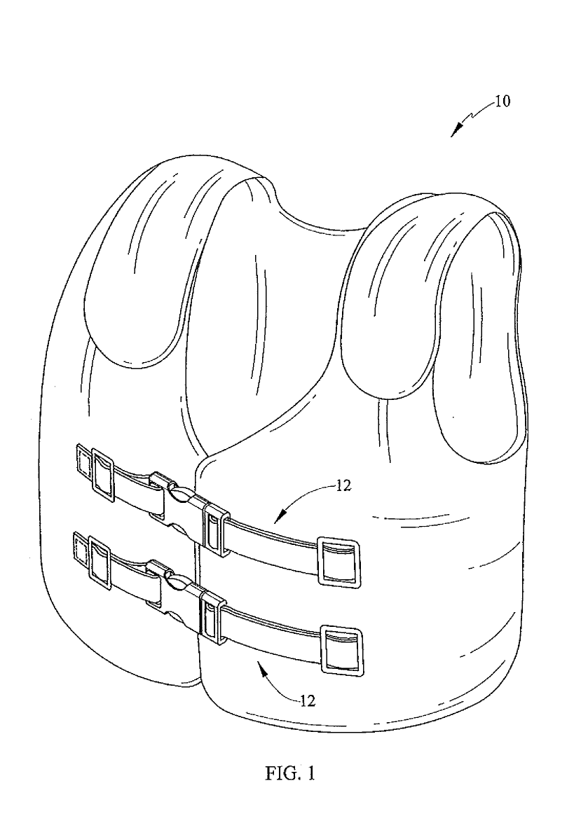

Garment based airway clearance systems and methods according to some illustrative embodiments are shown in FIGS. 1 through 8. FIG. 1 shows a garment 10 which is worn by a user during therapeutic use. Adjustable straps 12 allow for accommodation of users of various sizes.

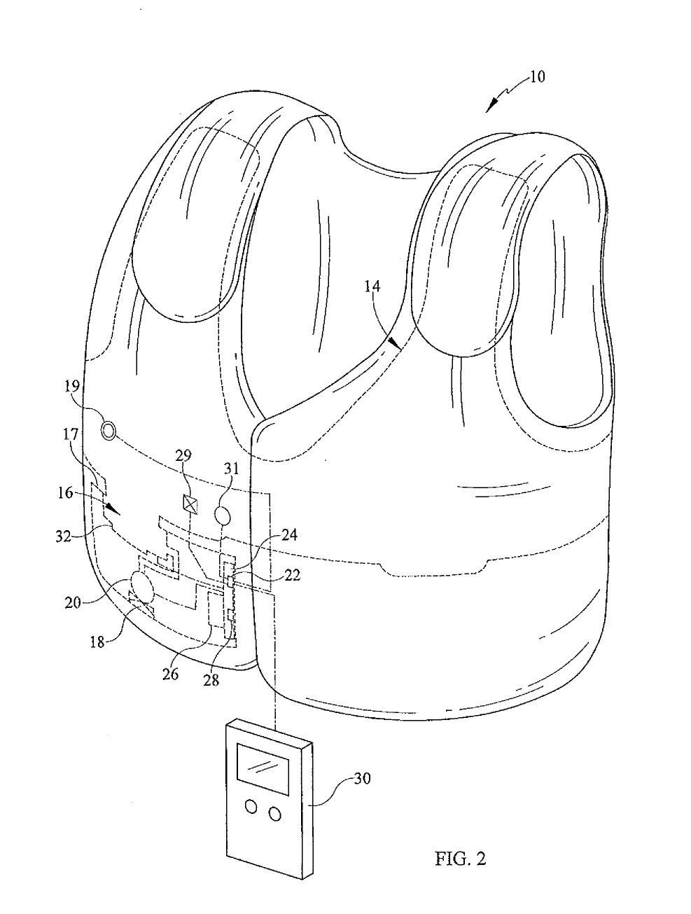

In the garment based airway clearance system shown in FIG. 2 the garment 10 comprises a therapy chamber 14 configured to retain fluid. Therapy chamber 14 is situated between at least two layers of the garment 10. In another embodiment, therapy chamber 14 is a bladder mounted on the garment 10. In this embodiment, therapy chamber 14 is mounted substantially around the circumference of the garment 10 such that inflation of the therapy chamber 14 causes a compressive force to be applied on the thorax or chest of the wearer of the garment 10. The therapy chamber 14 is fluidly connected to pulse generating chamber 16 via an orifice 33. The pulse generating chamber 16 is supplied fluid by a fluid supply 20. Fluid supply 20 is a blower in this embodiment, in another embodiment fluid supply 20 may be a compressor or a fan. Fluid supply 20 draws air from the environment in this embodiment through supply valve 18. In this embodiment, supply valve 18 is a mechanically regulated one way check valve. In another embodiment, supply valve 18 may be an electrically actuated two way valve controlled by processor 22, while in other embodiments the supply valve 18 may be any other type of valve mechanism that can selectively allow fluid flow. The processor 30 can be any device configured to receive at least one input signal while in another embodiment has the capability to provide at least one output signal in addition to comprising the capability to receive at least one input signal. Several types of processors may be used, including but not limited to programmable or preprogrammed types. In this embodiment, the supply valve 18 is a mechanically regulated one way cheek valve that allows for air flow to the fluid supply 20, but impedes flow back out to the environment. Although in this embodiment the supply valve 18 is situated between the fluid supply 20 and inlet from the environment, in another embodiment, the supply valve 18 may be situated between the fluid supply 20 and the pulse generating chamber 16.

An air pressure pulse generator 32 causes reduction in volume of the pulse generating chamber 16 thereby increasing pressure in therapy chamber 14 and pulse generating chamber 16. The air pressure pulse generator 32 is configured to cyclically actuate and thereby vary the volume of the pulse generating chamber 16 providing high frequency chest wall oscillation therapy in a frequency range of 5-20 Hertz in this embodiment while in another embodiment, the air pressure pulse generator 32 can actuate at any desirable frequency. As the air pressure pulse generator 32 actuates and cyclically reduces the volume of the pulse generating chamber 16, pressure waves are generated which are felt by a wearer of the garment 10 as pulses of compressive pressure. The compressive pressure pulses applied by the garment 10 to the thorax region of the wearer aspire to generate increased airflow velocities in the airway that create cough-like shear forces and decrease secretion viscosity. Both serve to assist patients in moving retained secretions from smaller airways to larger airways where they can more easily be removed by coughing. A processor 22 mounted on a printed circuit board (PCB) 24 provides control signals to the fluid supply 20 and the air pressure pulse generator 32. In this embodiment, the processor 22 controls the fluid supply 20 and the air pressure pulse generator 32 via a transistor based switch and amplification circuit mounted on the PCB 24. In another embodiment, the processor 22 may use any type of digital and/or analog circuits to control the fluid supply 20 and the air pressure pulse generator 32.

A pressure sensor 29 configured to measure pressure in the pulse generating chamber 16 and/or the therapy chamber 14 communicates the pressure reading via an electrical signal to the processor 22. The processor 22 also gets input from a temperature sensor 31 indicating the temperature in the pulse generating chamber 16 and/or the therapy chamber 14 via an electrical signal. A battery 26 supplies power to the PCB 24 and/or components mounted on the PCB 24. The battery 26 is a rechargeable type in this embodiment, while in another embodiment the battery 26 may be disposable. A power charging port 28 is mounted on the PCB 24 and allows for recharging the battery 26. The power charging port 28 in this embodiment is a Universal Serial Bus (USB) type connection, although in other embodiments, the power charging port may be of any type. In yet another embodiment, the power charging port 28 includes a transformer to convert an alternating current (AC) type input to a direct current (DC) supplied to the battery 26.

A relief valve 19 mounted in the fluidic reservoir formed by the therapy chamber 14 and the pulse generating chamber 16 is electrically controlled by the processor 22. The relief valve 19, controlled by the processor 22, serves to exhaust the air contained in the fluidic reservoir formed by the therapy chamber 14 and the pulse generating chamber 16 and is particularly useful to store the garment based airway clearance system 10 after use. In another embodiment, the relief valve 19 is a mechanical plug that is manually actuated by a user to exhaust air from the fluidic reservoir formed by the therapy chamber 14 and the pulse generating chamber 16.

The processor 22 communicates with a user interface 30 to receive commands and communicate messages. The processor 22 communicates with the user interface 30 via a wired connection in this embodiment, although in another embodiment, the processor 22 communicates with the user interface 30 wirelessly. In one embodiment, the processor 22 communicates with more than one user interfaces via a communication network, at least one of which is remote. The communication network may be of any type, including but not limited to Wide Area Network (WAN), Local Area Network (LAN), Virtual Private Network (VPN), telephone lines, optical communications, internet communications or telex. In this embodiment, a user interface 30 is configured to display alarms and other messages including but not limited to the therapy pressure, physiological parameters, frequency of oscillation, amplitude of oscillation and time spent in therapy. The user interface 30 allows for user inputs and commands including, but not limited to varying frequency and amplitude of actuation of the air pressure pulse generator 32, The garment 10 includes storage pocket 17 which houses one or more of mechanical and electrical components of the garment based airway clearance system. This pocket may be included in any suitable location of the garment including the anterior, posterior or shoulder regions of the garment.

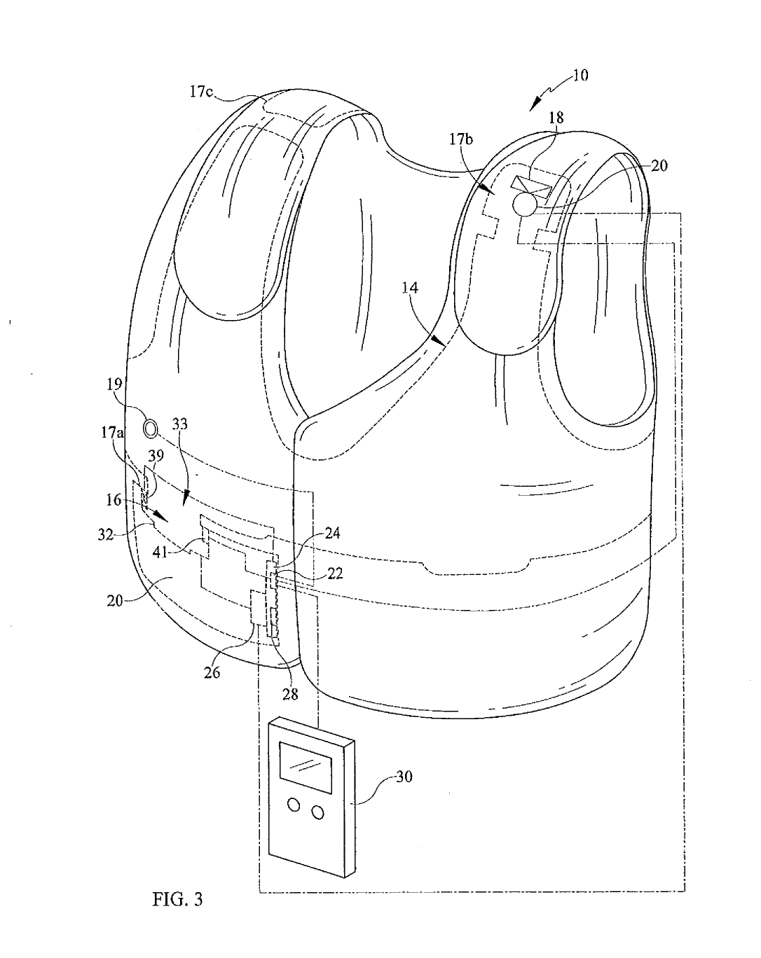

In the garment based airway clearance system shown in FIG. 3 the garment 10 comprises a therapy chamber 14 configured to retain fluid. Therapy chamber 14 is situated between at least two layers of the garment 10. In another embodiment, therapy chamber 14 is a bladder mounted on the garment 10. In this embodiment, therapy chamber 14 is mounted substantially around the circumference of the garment 10 such that inflation of the therapy chamber 14 causes a compressive force to be applied on the thorax of the wearer of the garment 10. The therapy chamber 14 is fluidly connected to pulse generating chamber 16 via an orifice 33. The pulse generating chamber 16 is supplied fluid by a fluid supply 20.

Fluid supply 20 is a blower in this embodiment, in another embodiment fluid supply 20 may be a compressor or a fan. Fluid supply 20 draws air from the environment in this embodiment through supply valve 18. In this embodiment supply valve 18 is a mechanically regulated one way check valve, in another embodiment, supply valve 18 may be an electrically actuated two way valve controlled by processor 22 or any other type of valve mechanism that can selectively allow fluid flow. The processor 30 can be any device configured to receive at least one input signal and in one embodiment have the capability to provide at least one output signal. Several types of processors may be used, including but not limited to programmable or preprogrammed types. In this embodiment, the supply valve 18 is a mechanically regulated one way check valve that allows for air flow to the fluid supply 20, but impedes flow back out to the environment. Although in this embodiment the supply valve 18 is situated between the fluid supply 20 and inlet from the environment, in another embodiment, the supply valve 18 may be situated between the fluid supply 20 and the pulse generating chamber 16. An air pressure pulse generator 32 causes reduction in volume of the pulse generating chamber 16 thereby increasing pressure in therapy chamber 14 and pulse generating chamber 16. The air pressure pulse generator 32 is configured to cyclically actuate and thereby vary the volume of the pulse generating chamber 16 providing high frequency chest wall oscillation therapy in a frequency range of 5-20 Hertz in this embodiment while in another embodiment, the air pressure pulse generator 32 can actuate at any desirable frequency. As the air pressure pulse generator 32 actuates and cyclically reduces the volume of the pulse generating chamber 16, pressure waves are generated which are felt by a wearer of the garment 10 as pulses of compressive pressure. The compressive pressure pulses applied by the garment 10 to the thorax region of the wearer aspire to generate increased airflow velocities in the airway that create cough-like shear forces and decrease secretion viscosity. Both serve to assist patients in moving retained secretions from smaller airways to larger airways where they can more easily be removed by coughing.

A processor 22 mounted on a printed circuit board (PCB) 24 provides control signals to a fluid supply controller 50 and a air pressure pulse generator controller 48. Fluid supply controller 50 processes the control signal provided by the processor 22 and operates the fluid supply accordingly while air pressure pulse generator controller 48 processes the control signal provided by the processor 22 and operates the air pressure pulse generator 32 accordingly. A pressure sensor 29 configured to measure pressure in the pulse generating chamber 16 and/or the therapy chamber 14 communicates the pressure reading via an electrical signal to the processor 22. The processor 22 also gets input from a temperature sensor 31 indicating the temperature in the pulse generating chamber 16 and/or the therapy chamber 14 via an electrical signal. A battery 26 supplies power to the PCB 24, fluid supply 20, air pressure pulse generator 32 and/or components mounted on the PCB 24. The battery 26 is a rechargeable type in this embodiment, while in another embodiment the battery 26 may be disposable. A power charging port 28 is mounted on the PCB 24 and allows for recharging the battery 26. The power charging port 28 in this embodiment is a Universal Serial Bus (USB) type connection, although in other embodiments, the power charging port may be of any type. In yet another embodiment, the power charging port 28 includes a transformer to convert an alternating current (AC) type input to a direct current (DC) supplied to the battery 26. A relief valve 19 mounted in the fluidic reservoir formed by the therapy chamber 14 and the pulse generating chamber 16 is electrically controlled by the processor 22. The relief valve 19, controlled by the processor 22, serves to exhaust the air contained in the fluidic reservoir formed by the therapy chamber 14 and the pulse generating chamber 16 and is particularly useful to store the garment based airway clearance system 10 after use. In another embodiment, the relief valve 19 is a mechanical plug that is manually actuated by a user to exhaust air from the fluidic reservoir formed by the therapy chamber 14 and the pulse generating chamber 16.

The processor 22 communicates with a user interface 30 to receive commands and communicate messages. The processor 22 communicates with the user interface 30 via a wired connection in this embodiment, although in another embodiment, the processor 22 communicates with the user interface 30 wirelessly. In one embodiment, the processor 22 communicates with more than one user interfaces via a communication network, at least one of which is remote. The communication network may be of any type, including but not limited to Wide Area Network (WAN), Local Area Network (LAN), Virtual Private Network (VPN), telephone lines, optical communications, internet communications or telex. In this embodiment, a user interface 30 is configured to display alarms and other messages including but not limited to the therapy pressure, physiological parameters, frequency of oscillation, amplitude of oscillation and time spent in therapy. The user interface 30 allows for user inputs and commands including, but not limited to varying frequency and amplitude of actuation of the air pressure pulse generator 32.

The garment 10 includes storage pockets 17a, 17b & 17c which house one or more of mechanical and electrical components of the garment based airway clearance system. These pockets may be included in any suitable location of the garment including the anterior, posterior or shoulder regions of the garment. In the embodiment shown in FIG. 3, fluid supply 20 and the supply valve 18 are located in storage pocket 17b located on the shoulder of the patient. The fluid supply 20 and the supply valve 18 are connected to the garment using straps in this embodiment. In another embodiment, they may be connected to the garment using any other means including but not limited to hook type connectors, buttons, zippered connection and or be sown in to the storage pocket. In yet another embodiment the storage pocket 17b which houses fluid supply 20 and the supply valve 18 comprises a flap which serves to selectively secure components in the storage pocket. Other components of the system including but not limited to the air pulse generator 32, PCB 24 and the battery 26 are also housed in at least one storage pocket and located using mechanical means, some of which are described above. In this embodiment, storage pockets of the garment which house mechanical and/or electrical components include dampening material lining the storage pockets to dampen any one of vibrations and/or heat transmitted to the wearer and/or sound.

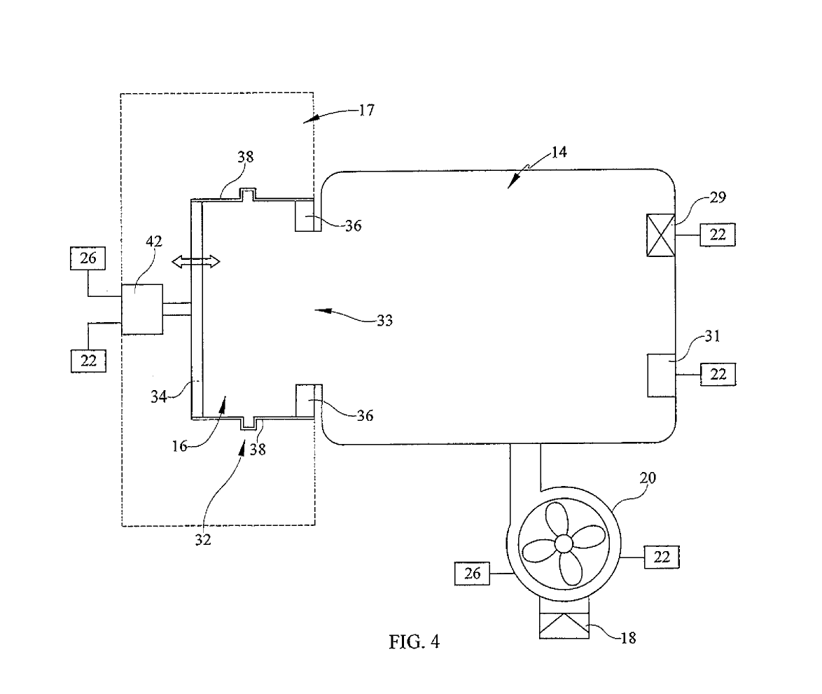

One embodiment of the air pressure pulse generator 32 and other components comprising the garment based airway clearance system is shown in FIG. 4. An actuator 42 actuates a moving plate 34 relative to a fixed plate 36 thereby deforming diaphragms 38 and reducing the volume of the pulse generating chamber 16. Although the actuator 42 contemplated in this embodiment is an electrical actuator, any other type of actuator may be used to actuate the moving plate relative to the fixed plate 34 including but not limited to pneumatic and hydraulic actuators. In this embodiment the volume defined by the fixed plate 36, moving plate 34 and diaphragms 38 comprises the pulse generating chamber 16. Diaphragm 38 extends substantially between the moving plate 34 and the fixed plate 36 so that the pulse generating chamber 16 is substantially fluid retentive in this embodiment, the moving plate 34 and the fixed plate 36 are made of a polymeric material although in other embodiments they may be made of metal or any other material. In this embodiment the fixed plate 36 allows the pulse generating chamber 16 to be located with respect to the garment by any type of mechanical locating support means including but not limited to hooked connections, buttons, pockets, adhesives and/or zippered connections. Diaphragms 38 are made of a polymeric material in this embodiment, deformation of which leads to at least a portion of the moving plate 34 moving relative to the fixed plate 36. In another embodiment, diaphragms 38 may be made of any material and/or design which would allow them to be of substantially lower stiffness than the fixed and moving plates along the path of motion between these two plates. in this embodiment, at least one of the moving plate 34, fixed plate 36, walls of the therapy chamber 14 and pulse generating chamber 16 are designed to conform to the portion of the human anatomy where the aforementioned component is located, in another embodiment, the aforementioned components may be of any shape.

Actuator 42 comprises a pulse generator controller 48 which actuates the actuator 42 based on control signals received from the processor 22. The actuator is also supplied power by the battery or power source 26. Pressure sensor 29 and temperature sensor 31 sense pressures and temperature respectively in the fluidic reservoir formed by the therapy chamber 14 and the pulse generating chamber 16 and communicate these readings via an electric signal to the processor 22. A fluid supply 20 supplies air to the fluidic reservoir formed by the therapy chamber 14 and the pulse generating chamber 16 by drawing air from the environment through supply valve 18. The fluid supply comprises a fluid supply controller 50 which actuates the fluid supply 20 based on control signals received from the processor 22. The actuator 42 is also supplied power by the battery or power source 26.

Although in this embodiment control and sense signals communicated between the fluid supply 20, actuator 42, pressure sensor 29, temperature sensor 31 and the processor 22 are communicated via electrical signals, any other type of signal may be used for communication including but not limited to wireless, optical and/or acoustic signals in other embodiments. As the actuator 42 actuates the moving plate towards the fixed plate 36 and compresses the pulse generating chamber 16, the pressure in fluidic reservoir formed by the therapy chamber 14 and the pulse generating chamber 16 varies as shown in equation 1 below, The air pressure pulse generator 32 is configured to cyclically actuate and thereby vary the volume of the pulse generating chamber 16 providing high frequency chest wall oscillation therapy in a frequency range of 5-20 Hertz in this embodiment while in another embodiment, the air pressure pulse generator 32 can actuate at any desirable frequency. As evident in equation (1) below, as the volume of the fluidic reservoir formed by the therapy chamber 14 and the pulse generating chamber 16 reduces upon reduction of volume of the pulse generating chamber 16, pressure in the fluidic reservoir formed by the therapy chamber 14 and the pulse generating chamber 16 increases.

Pressure_{compressed}=(Pressure_{uncompressed}+Volume_{uncompressed})/Volume_{compressed} (1)

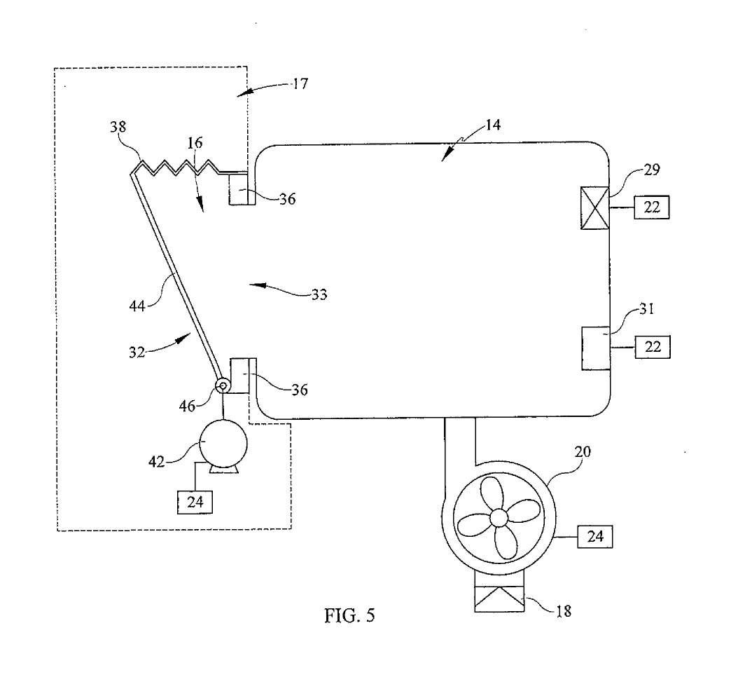

One embodiment of the air pressure pulse generator 32 and other components comprising one embodiment of the garment based airway clearance system is shown in FIG. 5. An actuator 42 actuates a pivoting plate 44 about a pivot axis 46 relative to a fixed plate 36 thereby deforming diaphragm 38 and reducing the volume of the pulse generating chamber 16. Although the actuator 42 contemplated in this embodiment is an electrical actuator, any other type of actuator may be used to actuate the moving plate relative to the fixed plate 34 including but not limited to pneumatic and hydraulic actuators. In this embodiment the volume defined by the fixed plate 36, pivoting plate 44 and diaphragm 38 comprises the pulse generating chamber 16. Diaphragm 38 extends substantially between the pivoting plate 44 and the fixed plate 36 so that the pulse generating chamber 16 is substantially fluid retentive. In this embodiment, the pivoting plate 44 and the fixed plate 36 are made of a polymeric material although in other embodiments they may be made of metal or any other material. In this embodiment the fixed plate 36 allows the pulse generating chamber 16 to be located with respect to the garment by any type of mechanical locating support means including but not limited to hooked connections, buttons, pockets, adhesives and/or zippered connections. Diaphragm 38 is made of a polymeric material in this embodiment, deformation of which leads to at least a portion of the pivoting plate 44 moving relative to the fixed plate 36. In another embodiment, diaphragm 38 may be made of any material and/or design which would allow it to be of substantially lower stiffness than the fixed and pivoting plates along the path of motion between these two plates. In this embodiment, at least one of the pivoting plate 44, fixed plate 36, walls of the therapy chamber 14 and pulse generating chamber 16 are designed to conform to the portion of the human anatomy where the aforementioned component is located, in another embodiment, the aforementioned components may be of any shape. Actuator 42 receives control signals from the processor 22 via the PCB 24. Pressure sensor 29 and temperature sensor 31 sense pressures and temperature respectively in the fluidic reservoir formed by the therapy chamber 14 and the pulse generating chamber 16 and communicate these readings via an electric signal to the processor 22. A fluid supply 20 supplies air to the fluidic reservoir formed by the therapy chamber 14 and the pulse generating chamber 16 by drawing air from the environment through supply valve 18. The fluid supply 20 receives control signals from the processor 22 via the PCB 24. Although in this embodiment control and sense signals communicated between the fluid supply 20, actuator 42, pressure sensor 29, temperature sensor 31 and the processor 22 are communicated via electrical signals, any other type of signal may be used for communication including but not limited to wireless, optical and/or acoustic signals in other embodiments. As the actuator 42 actuates the pivoting plate 44 towards the fixed plate 36 and compresses the pulse generating chamber 16, the pressure in fluidic reservoir formed by the therapy chamber 14 and the pulse generating chamber 16 varies as shown in equation 1 above. As evident in equation (1) above, as the volume of the fluidic reservoir formed by the therapy chamber 14 and the pulse generating chamber 16 reduces upon reduction of volume of the pulse generating chamber 16, pressure in the fluidic reservoir formed by the therapy chamber 14 and the pulse generating chamber 16 increases.

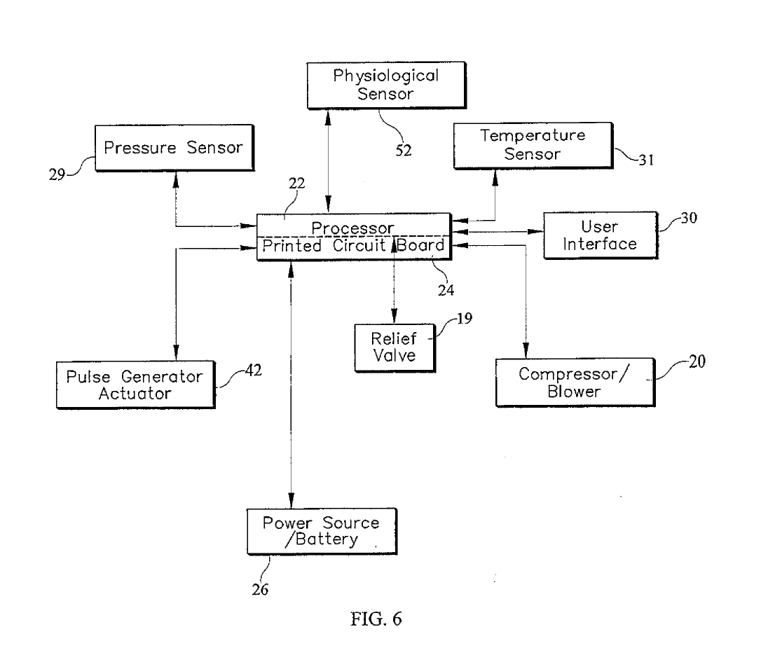

FIG. 6 shows in a block diagram connections of some components of the garment based airway clearance system in one embodiment. A processor 22 mounted on a printed circuit board (PCB) 24 provides control signals to the fluid supply 20 and the actuator 42. In this embodiment, the processor 22 controls the fluid supply 20 and the actuator 42 via a transistor based switch and amplification circuit mounted on the PCB 24, In another embodiment, the processor 22 may use any type of digital and/or analog circuits to control the fluid supply 20 and the air pressure pulse generator 32. A pressure sensor 29 configured to measure pressure in the pulse generating chamber 16 and/or the therapy chamber 14 communicates the pressure reading via an electrical signal to the processor 22. The processor 22 also gets input from a temperature sensor 31 indicating the temperature in the pulse generating chamber 16 and/or the therapy chamber 14 via an electrical signal. In this embodiment physiological sensor 52 is mounted on the garment 10 and communicates with the processor 22 by way of an electrical signal indicative of at least one physiological parameter, including but not limited to temperature, blood pressure, heart rate and electrical activity, in another embodiment, the physiological sensor 52 is an external device not mounted on the garment 10 which communicates with the processor 22. Processor 22 monitors the signals from the physiological sensor 52 and is configured to communicate a message to the user interface 30 in response to any of the physiological parameters not complying with a predetermined rule or threshold. A battery 26 supplies power to the PCB 24 and/or components mounted on the PCB 24. The battery 26 is a rechargeable type in this embodiment, while in another embodiment the battery 26 may be disposable. A relief valve 19 mounted in the fluidic reservoir formed by the therapy chamber 14 and the pulse generating chamber 16 is electrically controlled by the processor 22. The relief valve 19, controlled by the processor 22, serves to exhaust the air contained in the fluidic reservoir formed by the therapy chamber 14 and the pulse generating chamber 16 and is particularly useful to vent the fluidic reservoir before storing the garment based airway clearance system 10 after use. In another embodiment, the relief valve 19 is a mechanical plug that is manually actuated by a user to exhaust air from the fluidic reservoir formed by the therapy chamber 14 and the pulse generating chamber 16. In yet another embodiment, the supply valve 18 not shown in FIG. 6 is a two way valve controlled by the processor 22 and serves the function of exhausting air, thereby eliminating the need of a relief valve 19. The processor 22 communicates with a user interface 30 to receive commands and communicate messages. The processor 22 communicates with the user interface 30 via a wired connection in this embodiment, although in another embodiment, the processor 22 communicates with the user interface 30 wirelessly. In one embodiment, the processor 22 communicates with more than one user interfaces via a communication network, at least one of which is remote. The communication network may be of any type, including but not limited to Wide Area Network (WAN), Local Area Network (LAN), Virtual Private Network (VPN), telephone lines, optical communications, internet communications or telex, In this embodiment, a user interface 30 is configured to display alarms and other messages including but not limited to the therapy pressure, physiological parameters, frequency of oscillation, amplitude of oscillation and time spent in therapy. The user interface 30 allows for user inputs and commands including, but not limited to varying frequency and amplitude of actuation of the air pressure pulse generator 32. In this embodiment, the user interface 30 is a touch screen graphical input and/or output, in other embodiment, the user interface may comprise any combination of touchscreen, mechanical key based, audio and/or visual interface.

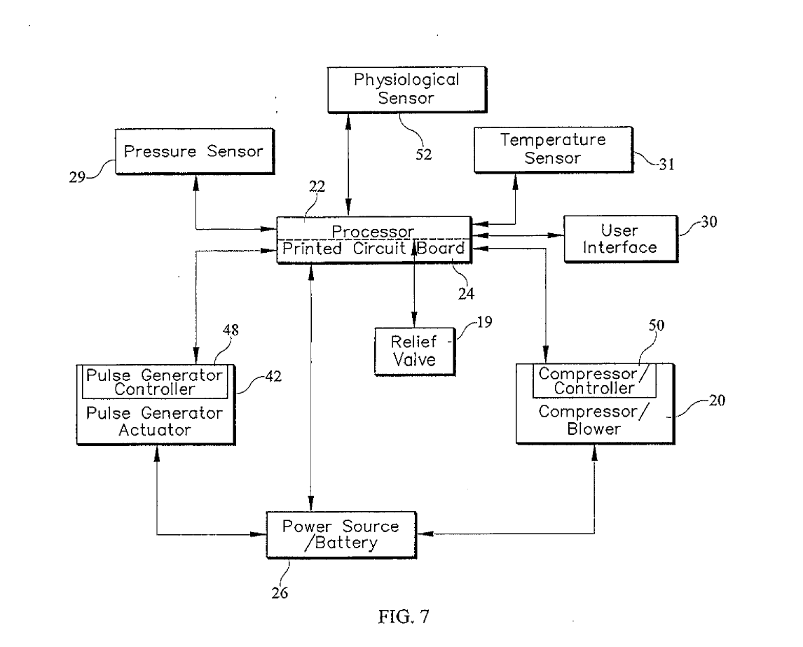

FIG. 7 shows in a block diagram connections of some components of a garment based airway clearance system of another embodiment. Actuator 42 comprises a pulse generator controller 48 which actuates the actuator 42 based on control signals received from the processor 22. The actuator 42 is also supplied power by the battery or power source 26. Pressure sensor 29 and temperature sensor 31 sense pressures and temperature respectively in the fluidic reservoir formed by the therapy chamber 14 and the pulse generating chamber 16 and communicate these readings via an electric signal to the processor 22. In this embodiment physiological sensor 52 is mounted on the garment 10 and communicates with the processor 22 by way of an electrical signal indicative of at least one physiological parameter, including but not limited to temperature, blood pressure, heart rate and electrical activity. In another embodiment, the physiological sensor 52 is an external device not mounted on the garment 10 which communicates with the processor 22. In this embodiment a fluid supply 20 supplies air to the fluidic reservoir formed by the therapy chamber 14 and the pulse generating chamber 16 by drawing air from the environment through supply valve 18. The fluid supply comprises a fluid supply controller 50 which actuates the fluid supply 20 based on control signals received from the processor 22. The fluid supply 20 is also supplied power by the battery or power source 26. Although in this embodiment control and sense signals communicated between the fluid supply 20, actuator 42, pressure sensor 29, physiological sensor 52, temperature sensor 31 and the processor 22 are communicated via electrical signals, any other type of signal may be used for communication including but not limited to wireless, optical and/or acoustic signals in other embodiments. The processor 22 communicates with a user interface 30 to receive commands and communicate messages. The processor 22 communicates with the user interface 30 via a wired connection in this embodiment, although in another embodiment, the processor 22 communicates with the user interface 30 wirelessly.

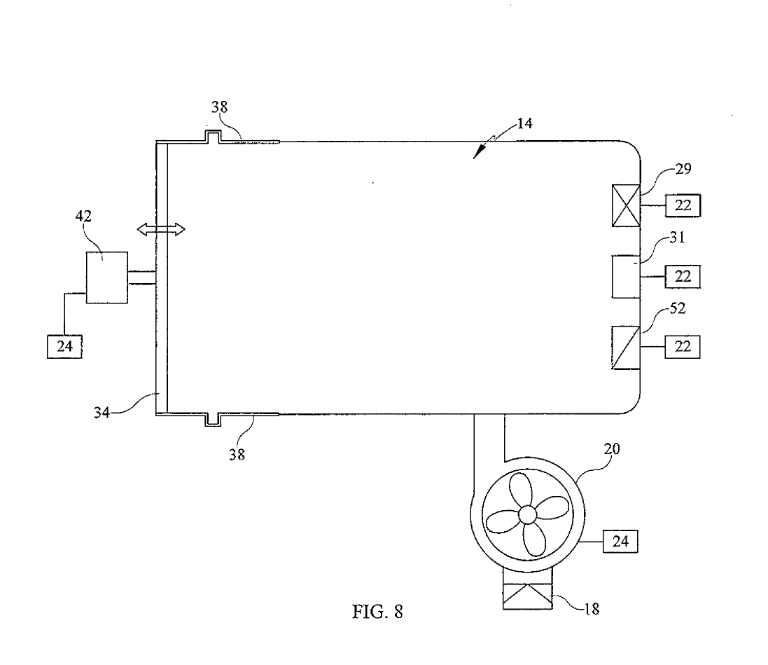

One embodiment of the air pressure pulse generator 32 and other components comprising the garment based airway clearance system is shown in FIG. 8. In this embodiment, the therapy chamber 14 has at least portion of its structure configured to be variably deformable by actuator 42. This portion of the therapy chamber's structure configured to be deformed by the actuator 42 comprises a moving plate 34 and diaphragms 38 in this embodiment. In another embodiment the moving plate itself deforms upon application of force by actuator 42 to reduce the volume of fluid inside the therapy chamber 14, thereby increasing pressure therein in which case diaphragms 38 need not be incorporated. In yet another embodiment, the region of the therapy chamber 14 configured to be actuated by the actuator 42 has a different stiffness as compared to other parts of the structure of the therapy chamber 14. In this embodiment, a single chamber in contemplated. The processor 22 is configured to communication with at least one of a pressure sensor 29, temperature sensor 31 and physiological sensor 52. Fluid supply 20 and actuator 42 get control signals from the processor 22 via the PCB 24. In this embodiment, supply valve 18 is a mechanical one way valve and allows air flow in to the fluid supply 20 from the environment. To vent fluid from the therapy chamber 14 after use, the fluid supply 20 is shut off and leakage in the connections and through the fabric of the therapy chamber 14 walls is relied upon in this embodiment. In another embodiment, a relief valve 19 is provided to vent air from the therapy chamber 14 while in yet another embodiment the supply valve 18 is a two way valve controlled by the processor 22. The actuator 42 is configured to cyclically actuate and thereby vary the volume of the therapy chamber 14 providing high frequency chest wall oscillation therapy in a frequency range of 5-20 Hertz in this embodiment while in another embodiment, the actuator 42 can actuate at any desirable frequency.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

The disclosures of any references and publications cited above are expressly incorporated by reference in their entireties to the same extent as if each were incorporated by reference individually.

We claim:

1. An airway clearance system for mobilizing secretions in a patient's airway, comprising:
a garment comprising with a first air retentive chamber;
a second air retentive chamber fluidly connected to said first air retentive chamber, said second air retentive chamber comprising a moving plate;
a fluid supply configured to supply air to at least one of said first air retentive chamber and said second air retentive chamber;
an actuator configured to actuate said moving plate to vary the volume of said second air retentive chamber, thereby varying the pressure in said first air retentive chamber and applying pressure on thoracic region of a wearer of said garment.

2. The airway clearance system of claim 1 further comprising a processor configured to send a control signal to said actuator.

3. The airway clearance system of claim 2 further comprising a pressure sensor configured to communicate pressure in at least one of said first air retentive chamber and said second air retentive chamber to said processor.

4. The airway clearance system of claim 2 further comprising a temperature sensor configured to communicate temperature in at least one of said first air retentive chamber and said second air retentive chamber to said processor.

5. The airway clearance system of claim 2 further comprising at least one physiological sensor configured to communicate an electrical signal indicative of at least one physiological parameter of a wearer of the garment to said processor.

6. The airway clearance system of claim 2 further comprising a user interface configured to communicate with said processor.

7. The airway clearance system of claim 6 wherein said user interface is configured to communicate wirelessly with said processor.

8. The airway clearance system of claim 1 wherein said actuator is configured to provide high frequency chest wall oscillation therapy with a frequency in the range of 5 to 20 Hertz.

9. The airway clearance system of claim 1 wherein said actuator is configured to translate said moving plate, thereby varying volume of said second air retentive chamber.

10. The airway clearance system of claim 1, wherein said actuator is configured to pivot said moving plate about a pivot axis, thereby varying volume of said second air retentive chamber.

11. The airway clearance system of claim 1 further comprising at least one valve to retain air in said first air retentive chamber and said second air retentive chamber.

12. The airway clearance system of claim 1 further comprising at least one valve to selectively exhaust air from said first air retentive chamber and said second air retentive chamber.

13. The airway clearance system of claim 1 wherein said garment comprises at least one pocket which houses said actuator.

14. A garment based airway clearance system for mobilizing secretions in a patient's airway, comprising:
a garment;
a fluid retentive chamber coupled with the garment and comprising at least one wall configured to actuate and thereby vary volume of said fluid retentive chamber;
a fluid supply coupled with the garment and configured to supply fluid to said fluid retentive chamber;
an actuator coupled with the garment and configured to actuate said at least one wall to vary the volume and thereby the pressure inside said fluid retentive chamber.
a processor configured to provide command signals to said actuator.

15. The garment based airway clearance system of claim 14 further comprising a pressure sensor configured to communicate pressure in said fluid retentive chamber to said processor.

16. The garment based airway clearance system of claim 14 further comprising a temperature sensor configured to communicate temperature in said fluid retentive chamber to said processor.

17. The garment based airway clearance system of claim 14 further comprising at least one physiological sensor configured to communicate an electrical signal indicative of at least one physiological parameter of a wearer of the garment to said processor.

18. The garment based airway clearance system of claim 14 further comprising a user interface configured to communicate with said processor.

19. The garment based airway clearance system of claim 18 wherein said user interface is configured to communicate wirelessly with said processor.

20. The garment based airway clearance system of claim 14 further comprising at least one valve to retain fluid in said fluid retentive chamber.

21. The garment based airway clearance system of claim 14 further comprising at least one valve to selectively exhaust fluid from said fluid retentive chamber.

22. A garment based airway clearance system for mobilizing secretions in a patient's airway, comprising:
means for varying volume of a fluid retentive chamber thereby varying pressure in said fluid retentive chamber, wherein pressure variation in said fluid retentive chamber serves to apply a pressure pulse to thoracic region of a wearer of the garment.

23. The garment based airway clearance system of claim 22 further comprising the means for providing high frequency chest wall oscillation therapy with a frequency in the range of 5-20 Hertz.

24. A garment based airway clearance system for mobilizing secretions in a patient's airway, comprising:
a fluid retentive chamber comprising at least one wall configured to pivot about a pivot axis and thereby vary volume of said fluid retentive chamber;
an actuator configured to actuate said at least one wall to vary the volume and thereby the pressure inside said fluid retentive chamber.

25. A garment based airway clearance system for mobilizing secretions in a patient's airway, comprising:
a fluid retentive chamber comprising a moving plate configured to translate with respect to a stationary plate and thereby vary volume of said fluid retentive chamber;
an actuator configured to actuate said moving plate to vary the volume and thereby the pressure inside said fluid retentive chamber.
